(19) United States
(12) Patent Application Publication
(10) Pub. No.: US 2010/0211459 A1
(43) Pub. Date: Aug. 19, 2010

(54) Method of Automatically Controlling the Display of a Webpage on a Device

(76) Inventors: Robert Seeman, London (GB); Peter Langley, London (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(21) Appl. No.: 12/676,647

(22) PCT Filed: Sep. 5, 2008
(86) PCT No.: PCT/GB2008/050793

§ 371 Date: Mar. 5, 2010

(30) Foreign Application Priority Data
Sep. 5, 2007 (GB) 0717245.5

(51) Int. Cl. G06Q 30/00; G06Q 10/00; G06F 15/16; G06F 3/048

(52) U.S. Cl. 705/14.46; 705/14.59; 705/14.69; 705/14.71; 705/14.73; 705/34; 709/203; 715/760

(57) ABSTRACT

In this invention, if an end-user has not interacted with a displayed webpage (the “Original”) displayed on a device for more than a defined time (i.e. a period of inactivity, called the “Delay”), then the device browser is automatically forwarded or pointed to a replacement webpage (the “Destination”) designated by the user or a third party. Hence, the Original will no longer remain displayed, long after it has been read, but will dynamically forward to a new Destination.

### BACKGROUND OF THE INVENTION

1. Field of the Invention

The field of the invention is a method of automatically controlling the display of a webpage on a device, together with hardware adapted to implement the method.

2. Technical Background

Viewers view web content using web browsers. But sometimes content remains on screen for long periods of time, with no viewer interaction with the web browser. The term ‘web’ should be construed to include not merely the web as conforming to W3C or IETF standards, but also similar structured information standards, such as WAP, and developments and enhancements to those standards.

3. Discussion of Related Art

Viewers view web content using browsers e.g. Safari™, Firefox™, or Microsoft™ Internet Explorer. But sometimes web content remains on the screen for long periods of time, with no viewer interaction with the web browser. The web browser waits apparently passively for the next user interaction, such as via a keyboard or via a mouse.

### SUMMARY OF THE INVENTION

There is provided a method of controlling the display of a webpage on a device, in which the device is displaying an original webpage, the method including the steps of, if the end-user of the device has not interacted with the original webpage for a defined time or delay:

(a) replacing the original webpage automatically with a new, replacement webpage.

This automatic replacement can be useful to a typical user; for example, the user might have a special interest in tracking stock prices, or seeing a webcam of a favourite beach, or having the latest news headlines, or having a search page as a default. With this invention, if the user is browsing a web site but fails to interact with the displayed page for more than a defined time (say 1 minute), then there is a good chance that the web page is no longer of interest to the user. Perhaps he has started on a different task and the browser window is obscured by some word processing documents, or an email application. When the user moves back to the browser window, the user, instead of being shown the stale webpage which he is no longer interested in, is shown a webpage that he is genuinely interested in seeing on a regular and ongoing basis (e.g. a Google™ search page, stock price listings, a webcam of a favourite beach, the latest news headlines etc). This is a better experience for the user. It also saves the user the time and trouble of manually selecting the web page that he is genuinely interested in seeing on a regular and ongoing basis.

It also increases the perceived personalization of the device, and hence its value. Personalisation is especially important where the device is a personal device, such as a mobile telephone or similar personal, portable device capable of web browsing. For device manufacturers, who need to be able to offer product differentiation at low cost, the present invention is especially useful.

The method may be one in which the device is caused to automatically download the replacement webpage from a remote web server after the defined time period of non-interaction.

The method may be one in which the displayed webpage itself automatically changes, within the same browser window, from the original to the replacement webpage.

The method may be one in which the end-user can hit the “back” browser instruction or link on the replacement webpage to return to the original webpage.

The method may be one in which the original webpage includes sponsored links and the replacement webpage is associated with one of those sponsored links.

The method may be one in which the replacement webpage is associated with the sponsored link that has paid to be featured on the replacement webpage.

The method may be one in which the replacement webpage is associated with the sponsored link that has paid to be the replacement webpage.

The method may be one in which computer code recognized by a web-browser measures inactivity time to enable the forwarding to the destination web site after the delay.

The method may be one in which the original website installs the code on their web server.

The method may be one in which a timer measuring the delay is reset or temporarily halted upon any evidence of end-user interaction with the original webpage.

The method may be one in which there is tracking of the following parameter as part of a process related to billing the entity controlling the replacement webpage: the amount and timing of payment or payments.

The method may be one in which there is tracking of the following parameter as part of a process related to payment to an entity controlling the original webpage: the period over which the forward to the replacement webpage is enabled.

The method may be one in which there is tracking of the following parameter as part of a process related to payment to an entity controlling the original webpage: the delay time selected by the advertiser or other entity controlling the replacement webpage.

The method may be one in which there is tracking of the following parameter as part of a process related to payment to an entity controlling the original webpage: bidding between competing advertisers.

The method may be one in which there is tracking of the following parameter as part of a process related to payment to an entity controlling the original webpage: how many webpages are actually forwarded to the replacement webpage.

The method may be one in which there is tracking of the following parameter as part of a process related to payment to an entity controlling the original webpage: the revenue that the entity controlling the replacement web site makes from either sales, either directly or indirectly through pay-per impression (PPI) ads, pay-per-action (PPA) ads or PPC ads.

The method may be one in which there is tracking of the following parameter as part of a process related to billing the entity controlling the replacement webpage: the number of times the replacement web site replaces the original web site.

The method may be one in which there is tracking of the following parameter as part of a process related to billing the entity controlling the replacement webpage: the revenue that the entity controlling the replacement web site makes from either sales, either directly or indirectly through PPI ads, PPA ads or PPC ads.

The method may be one in which the destination webpage is a frame within the original webpage.

The method may be one in which a higher value associated with the original web page implies a shorter time before the destination webpage appears.

The method may be one in which the replacement webpage appears only for non-subscription services.

Other aspects include a web server adapted to implement any of the methods described above; a Web browser application adapted to implement any of the methods described above and also a computing device when adapted to implement any of the methods described above.

### BRIEF DESCRIPTION OF THE DRAWINGS

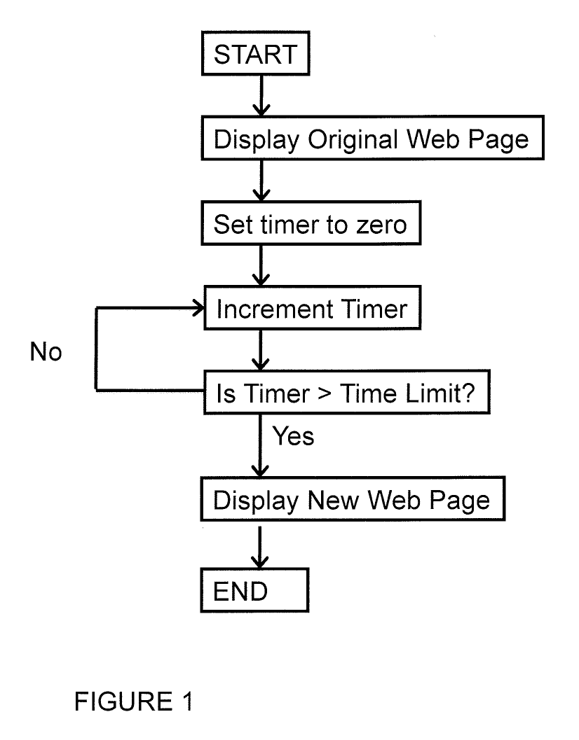

FIG. 1 shows a method of controlling the display of a webpage on a device, in which the device is displaying an original webpage, the method including the steps of, if the end-user of the device has not interacted with the original webpage for a defined time or delay:
(a) replacing the original webpage automatically with a new, replacement webpage.

### DETAILED DESCRIPTION

In one implementation of this invention, if an end-user has not interacted with a displayed webpage (the “Original”) displayed on a device for more than a defined time (i.e. a period of inactivity, called the “Delay”), then the device browser is automatically forwarded or pointed to a replacement webpage (the “Destination”) designated by the end-user or a third party—typically an advertiser. Hence, the Original will no longer remain displayed, long after it has been read, but will dynamically forward to a new Destination.

FIG. 1 shows an example of the invention. FIG. 1 shows a method of controlling the display of a webpage on a device, in which the device is displaying an original webpage, the method including the steps of, if the end-user of the device has not interacted with the original webpage for a defined time or delay:
(a) replacing the original webpage automatically with a new, replacement webpage.

Many users of PCs keep a web browser window open on their PC desktop, either dragged to one edge or minimized. So, after they have done their web browsing, they will revert to another task, such as word processing. Normally, the web browser will keep displaying the last page visited by the end-user. But with the present invention, the Original will automatically change to the Destination if the user does not interact with the browser for a pre-defined time—e.g. if the user does not click anywhere within the browser window for the predefined time, or does not interact with the device for the predefined time, e.g. by moving the mouse etc. Hence, when the user next looks at the browser, it will be displaying the Destination: this may well be of relevance to the end-user (in one implementation, the user actually sets the Destination in advance as setting in the web browser). If not, the user can readily revert to the Original by selecting the ‘back’ button or a similar link inserted on the destination page or in a web browser frame. The Original itself automatically changes within the same browser window from the Original to the Destination after the Delay. In this way, the valuable browser screen real estate is effectively used for new content, but in a manner that is not irritating to the end-user, but actually helpful.

This invention does not relate to the known technology of either pop-ups (either under or over the webpage) or Flash™ ads appearing above a webpage. Pop-ups and Flash™ ads are annoying to the user since they are separate windows which must then be manually closed. Further, many web-browser have features to block pop-up windows.

The Destination will only appear after the user has viewed the Original.

Advertisements in the prior art that appear temporarily above and obscuring the display of a webpage are often annoying to users that wish to read the webpage contact without delay. This implementation of the invention permits the display of the webpage content immediately, with the advertisement appearing only after the Delay; the presentation of the advertisement can be readily set back in time by any interaction with the device, such as moving a mouse or touching a trackpad or key.

Example

The Original may be any webpage (which term includes a WAP page or any other kind of remotely hosted, structured content) including search engine results, online news, blog etc.

For example, if after a minute of waiting, after the display of search results from a search engine with sponsored links or ads, the user has not selected any link, the webpage would forward to the webpage of one of the sponsored links or ads. It is possible, that, in this case, the webpage would forward to the highest paying sponsored link or ad.

The ideal Original is one that would normally take most users a specified amount of time to review, which time is less that the Delay. Therefore, in most cases the Original would have already been fully reviewed prior to the forwarding taking place. A longer Delay would be better for webpages that take longer for a user to review.

The Destination may also be a frame within the same window as the Original. For example, if the Original is a search engine, the search engine brand and search line, may appear in one, perhaps top, frame and the Destination would appear in a second frame. This frame could have a link providing for navigation back from the Destination to the Original.

Technology

The technology behind this would be any computer code recognized by a web-browser which enables the forwarding to the Destination after the Delay. A website wishing to use this service would first need to install this code on their website/web server.

This could also be especially useful for mobile phones, where there is a lot of renewed interest in advertising based business models. Automatically displaying a new web (or WAP or similar) page after the browser has remained quiescent for a given time is a very effective tool for mobile telephones.

Websites (WAP sites etc) that implement this feature could log and time the activity of all IP addresses that are being served. Alternatively, the timing might possibly be implemented client side via a form of browser recognised computer code that has a routine that measures accurate or approximately accurate time (Flash™ and audio can have accurate timing) or is able to read the computer's internal clock.

The Delay “clock” may be reset if the user's mouse (or other input device) is moved, or if there is any other evidence of user interaction with the original webpage. Alternatively, the clock could stop temporarily when the mouse is moving. Further, any mouse movement may be ignored completely, which is the ideal method since the mouse may be active for a non-browser application.

The Delay may be established in many ways, including based on the amount that the advertiser is prepared to pay. The more the advertiser pays, the faster the forwarding occurs.

A forward may commonly occur after a user has reviewed the webpage for a variety of reasons. The user may have completed the review and seen nothing of interest to pursue further with further browsing. The user could also be then distracted by or busy with some other matter, such as the telephone or another computer application.

The Destination may, in one implementation, be any webpage designated by an advertiser. It could be the advertiser's home page, product page or catalog page. It could also be a webpage with a high percentage of pay-per-click (PPC) advertisements. Such ads may be selected for relevance based on an analysis of the content of the Original. The analysis could be a keyword comparison similar to how relevant Google™ Ads are displayed on blog or newspaper sites now. The difference is that here the PPC ads are based on the content of the Original page. An advantage of this invention over current Google Ad placement is that there is more screen space to place more ads, i.e. potentially the entire webpage, and there can be less or no content to distract the user from clicking on one of the PPC links and generating revenue.

In another implementation, the Destination is set by the user in advance as a default in their web browser.

With mobile phone browsers, there is limited screen area. For example, Google's Gmail™ on a PC computer displays text ads beside each email. But Gmail™ on a mobile phone does not display any advertisements, likely as a result of the limited screen area. But displaying advertisement web pages (or other web pages selected by the user to be of interest to him) becomes readily possible with this invention, and without taking up valuable screen area at a time when it needs to be used to display other information.

Payment where Advertisements are Shown

The Original owner could be paid in a variety of ways, including based on one or more of:
the time period in which the forward is enabled regardless of the number of actually forwards;
the delay time requested by the advertiser or other entity controlling the replacement webpage;
upon bidding between competing advertisers, each with their own potential replacement webpages;
how many WebPages are actually forwarded to the Destination; or
the revenue that the advertiser makes from either sales, either directly or indirectly through PPI ads, PPA ads or PPC ads.

Appropriate tracking of the associated parameters, to pay the Original owner and to bill the Destination owner, is required.

Further Implementations

In an implementation, the time before the advertisement appears on the web browser depends on the value of the content to be displayed on the web browser. A higher value implies a shorter time before the advertisement appears. (e.g. A story about a famous supermodel may be rated higher value than a story about someone losing their pet).

In an implementation, a method is provided for a website, where website content is supplied as either subscription (with no or fewer advertisements) or non-subscription (advertisements appear after a certain time of inactivity at the user to web browser interface, and the time may be less for more valuable content). Subscription content may or may not include paying by content usage.

In an implementation, a web page is presented like content on a TV channel with advertising: the user receives the content for a fixed time (e.g. 1 minute), then the advertisements are received for a fixed time (e.g. 15 seconds), in succession. Optionally, the web site doesn't respond to attempts by the user using the same browser (or using a different browser on the same machine) to open a second browser page to the same site, so as to avoid the equivalent of channel-hopping in TV viewing by the user in order to avoid the advertisements. Also, web site response to a Back then Forwards operation in a browser (performed to try to set the clock back to zero for the web page, to cancel the advertisements) is to keep the clock running from the previous access to the web page, to discourage/prevent this practice.

Advertisements may include sponsored links.

1. A method of controlling the display of a webpage on a device, in which the device is displaying an original webpage, the method including the steps of, if the end-user of the device has not interacted with the original webpage for a defined time or delay:
(a) replacing the original webpage automatically with a new, replacement webpage;
(b) automatically causing a signal to be sent to a computer server that tracks events as part of a payment or billing related process.

2. The method of claim 1 in which the device is caused to automatically download the replacement webpage from a remote web server after the defined time period of non-interaction.

3. The method of claim 1 in which the displayed webpage itself automatically changes, within the same browser window, from the original to the replacement webpage.

4. The method of claim 3 in which the end-user can hit the “back” browser instruction or link on the replacement webpage to return to the original webpage.

5. The method of claim 1 in which the original webpage includes sponsored links and the replacement webpage is associated with one of those sponsored links.

6. The method of claim 5 in which the replacement webpage is associated with the sponsored link that has paid to be featured on the replacement webpage.

7. The method of claim 5 in which the replacement webpage is associated with the sponsored link that has paid to be the replacement webpage.

8. The method of any preceding claim 1 in which computer code recognized by a web-browser measures inactivity time to enable the forwarding to the destination web site after the delay.

9. The method of claim 8 in which the original website installs the code on their web server.

10. The method of claim 1 in which a timer measuring the delay is reset or temporarily halted upon any evidence of end-user interaction with the original webpage.

11. The method of claim 1 in which there is tracking of one or more of the following parameters as part of a process related to billing the entity controlling the replacement webpage:
(a) the amount and timing of payment or payments;
(b) the number of times the replacement web site replaces the original web site;
(c) the revenue that the entity controlling the replacement web site makes from either sales, either directly or indirectly through PPI ads, PPA ads or PPC ads.

12. The method of claim 1 in which there is tracking of one or more of the following parameters as part of a process related to payment to an entity controlling the original webpage:
(a) the period over which the forward to the replacement webpage is enabled;
(b) the delay time selected by the advertiser or other entity controlling the replacement webpage;
(c) bidding between competing advertisers;
(d) how many webpages are actually forwarded to the replacement webpage;
(e) the revenue that the entity controlling the replacement web site makes from either sales, either directly or indirectly through PPI ads, PPA ads or PPC ads.

13-18. (canceled)

19. The method of claim 1 in which the destination webpage is a frame within the original webpage.

20. The method of claim 1 in which a higher value associated with the original web page implies a shorter time before the destination webpage appears.

21. The method of claim 1 in which the replacement webpage appears only for non-subscription services.

22. The method of claim 1 in which the replacement webpage is defined or selected in advance by the user.

23. The method of claim 1 in which the replacement webpage is a search engine webpage.

24-27. (canceled)

28. A computing device adapted to display a webpage, in which the device displays an original webpage, and, if the end-user of the device has not interacted with the original webpage for a defined time or delay, the device is adapted to:
(a) replace the original webpage automatically with a new, replacement webpage;
(b) automatically cause a signal to be sent to a computer server that tracks events as part of a payment or billing related process.

29. A computer server that a computer server that tracks events as part of a payment or billing related process, the server receiving a signal from a computing device adapted to display a webpage, in which the device displays an original webpage, and, if the end-user of the device has not interacted with the original webpage for a defined time or delay, the computing device is adapted to:
(a) replace the original webpage automatically with a new, replacement webpage;
(b) automatically cause a signal to be sent to the computer server that tracks events as part of a payment or billing related process;
and in which the computer server tracks of one or more of the following parameters as part of a process related to billing the entity controlling the replacement webpage:
(a) the amount and timing of payment or payments;
(b) the number of times the replacement web site replaces the original web site;
(c) the revenue that the entity controlling the replacement web site makes from either sales, either directly or indirectly through PPI ads, PPA ads or PPC ads.

30. The computer server of claim 29 which tracks of one or more of the following parameters as part of a process related to payment to an entity controlling the original webpage:
(a) the period over which the forward to the replacement webpage is enabled;
(b) the delay time selected by the advertiser or other entity controlling the replacement webpage;
(c) bidding between competing advertisers;
(d) how many webpages are actually forwarded to the replacement webpage;
(e) the revenue that the entity controlling the replacement web site makes from either sales, either directly or indirectly through PPI ads, PPA ads or PPC ads.
